(19) United States
(12) Patent Application Publication
(10) Pub. No.: US 2024/0303343 A1
(43) Pub. Date: Sep. 12, 2024

(54) PARTITIONING OF PROCESSOR SOCKETS

(71) Applicant: Intel Corporation, Santa Clara, CA (US)

(72) Inventors: Yi ZENG, Shanghai (CN); Russell J. WUNDERLICH, Livermore, CO (US); Janusz JURSKI, Beaverton, OR (US); Lumin ZHANG, Shanghai (CN); Kasper WSZOLEK, Gdansk (PL); Jeanne GUILLORY, Reseda, CA (US); Ching Yu LO, Taipei (TW); Teresa C. HERRICK, Folsom, CA (US); Richard Marian THOMAIYAR, Trichy (IN)

(21) Appl. No.: 18/666,693

(22) Filed: May 16, 2024

(30) Foreign Application Priority Data
Dec. 16, 2023 (WO) PCT/CN2023/139319

(51) Int. Cl. G06F 21/57; G06F 1/06

(52) U.S. Cl. CPC G06F 21/575; G06F 1/06; G06F 21/572

(57) ABSTRACT

Examples described herein relate to multiple processor sockets comprising processors connected thereto and first circuitry. The first circuitry is to: based on a first mode of operation: configure the multiple processor sockets to operate with a single memory address space and share interfaces and based on a second mode of operation: configure the interfaces accessible to the multiple processor sockets to provide isolated communications to processor sockets in different partitions and configure the multiple processor sockets to operate in independent memory address spaces.

### RELATED APPLICATION

This application claims the benefit of priority to Patent Cooperation Treaty (PCT) Application Number PCT/CN2023/139319, filed Dec. 16, 2023. The entire contents of that application are incorporated by reference.

### BACKGROUND

A motherboard can include multiple processor sockets that communicate with each other to increase available processor and cache and memory resources. For example, by communication among multiple processor sockets, available cache size and memory resources can increase. For example, Intel® Xeon processor sockets can be connected in various configurations, such as 1 socket (1S), 2 socket (2S), 4 socket (4S), 8 socket (8S), or above 8S configurations.

### BRIEF DESCRIPTION OF THE DRAWINGS

FIG. 1 depicts an example system.

FIG. 2 depicts an example system.

FIG. 3 depicts an example switch.

FIG. 4A depicts an example configuration of a management controller.

FIG. 4B depicts an example configuration of a management controller.

FIG. 5 depicts an example process.

FIG. 6 depicts an example system.

### DETAILED DESCRIPTION

Platforms can scale up or down a number of sockets in a partition and boot either as multi-socket platform or as multi-node systems. This scalability allows a two-socket (2S) platform to boot either as one platform with two sockets (1×2S) or as two platforms with one socket each (2×1S) or a four-socket (4S) platform to boot as two platforms with two sockets each (2×2S).

Some computer systems utilize a chipset architecture that include a central processing unit (CPU) coupled to a Platform Controller Hub (PCH). The PCH provides General Purpose Input Output (GPIO) used by platform devices to communicate with software executed by the CPU. Bootable CPUs are a class of CPUs that remove a PCH and integrate boot, early reset, power management, and IOs of the PCH into the CPU complex. Various examples provide for socket level partitioning of resources of processor sockets including one or more of: partition mode selection before CPU exits reset or dynamically and independent of CPU exiting reset, control hardware strap configuration based on partition mode, cross socket interface isolation for high speed input output (I/O) and low speed interfaces, partitioning of clock signals, partitioning of debug topology, in-band and out-of-band management interface support, partitioning platform root of trust, or others.

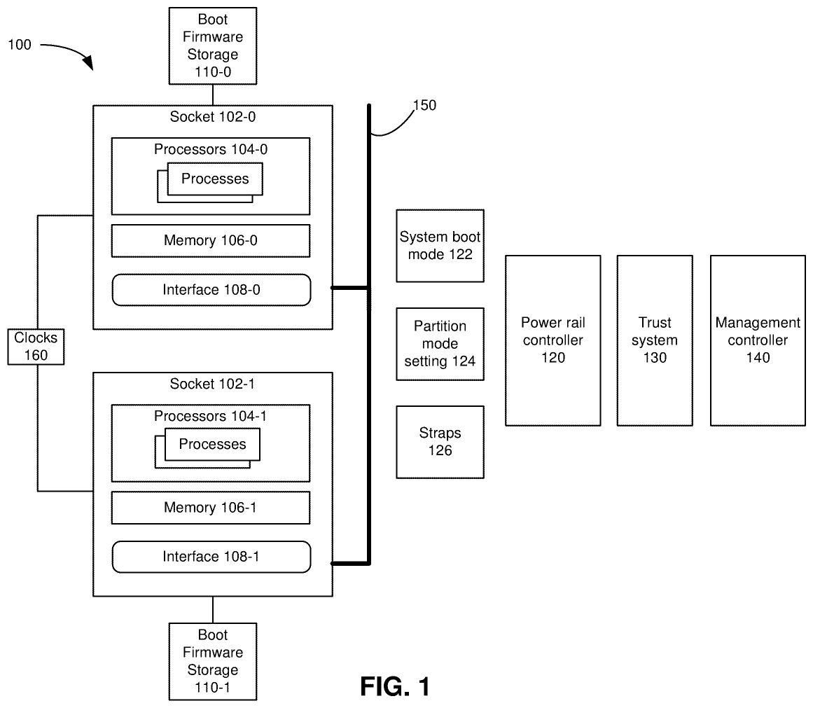

FIG. 1 depicts an example system. One or more of processor sockets 102-0 to 102-1 can include mechanical components that provide mechanical and electrical connections between processors 104-0 to 104-1 and associated printed circuit board (PCB), when connected to the PCB. In some examples, one or more of processors 104-0 to 104-1 can include one or more of: a central processing unit (CPU), a processor core, graphics processing unit (GPU), neural processing unit (NPU), general purpose GPU (GPGPU), field programmable gate array (FPGA), application specific integrated circuit (ASIC), tensor processing unit (TPU), or other circuitry. A socket can include a ball grid array (BGA), Pin Grid Array (PGA), Land Grid Array (LGA), or other interface that can couple a processor (e.g., processors 104-0 or 104-1) to a circuit board (e.g., printed circuit board (PCB)), without soldering the processor to the circuit board.

A processor core can include an execution core or computational engine that is capable of executing instructions. A core can access to its own cache and read only memory (ROM), or multiple cores can share a cache or ROM. Cores can be homogeneous (e.g., same processing capabilities) and/or heterogeneous devices (e.g., different processing capabilities). Frequency or power use of a core can be adjustable. A core can be sold or designed by Intel®, ARM®, Advanced Micro Devices, Inc. (AMD)®, Qualcomm®, IBM®, Nvidia®, Broadcom®, Texas Instruments®, or compatible with reduced instruction set computer (RISC) instruction set architecture (ISA) (e.g., RISC-V), among others.

Processors can be heterogeneous or homogeneous processor types where processors in different sockets are a same type (e.g., CPU, GPU, NPU, etc.) or different type. (e.g., a first socket includes a CPU and a GPU and a second socket includes a GPU and an NPU). One or more of processors 104-0 to 104-1 can be implemented as a bootable processor that includes boot circuitry that can manage loading and execution of the firmware to boot a CPU and an associated platform. A bootable processor can include a class of processors that remove a PCH and integrate boot, early reset, power management, and IOs of the PCH into the CPU complex.

Interfaces 108-0 to 108-1 can provide communications among processor sockets 102-0 to 102-1 using I/O interface 150. In some examples, interfaces 108-0 to 108-1 can operate in a manner consistent at least with Infinity Fabric from Advanced Micro Devices, Inc. (AMD), AMD HyperTransport, NVIDIA® NVLink, Intel® QuickPath Interconnect (QPI), Advanced Microcontroller Bus Architecture (AMBA), Coherent Hub Interface (CHI) Chip to Chip (C2C), TileLink, RISC-V processor interconnect, Intel® Ultra Path Interconnect (UPI), Intel® On-Chip System Fabric (IOSF), Omnipath, Compute Express Link (CXL) (see, for example, Compute Express Link Specification revision 2.0, version 0.7 (2019), as well as earlier versions, later versions, and variations thereof), Peripheral Component Interconnect express (PCIe) (see, for example, Peripheral Component Interconnect (PCI) Express Base Specification 1.0 (2002), as well as earlier versions, later versions, and variations thereof), or other public or proprietary standards.

Although two processor sockets are shown, examples can apply to more than two processor sockets. For example, one multiple socket system can be configured as one multiple socket system that uses a single memory address space. For example, multiple X socket systems, where X is an integer of 1 or more, can be configured to use multiple different memory address spaces.

In some examples, interface 150 can provide communication using one or more of the following protocols: Improved Inter Integrated Circuit (I3C), Universal Serial Bus Type-C (USB-C), serial peripheral interface (SPI), enhanced SPI (eSPI), System Management Bus (SMBus), Inter-Integrated Circuit (I2C), MIPI I3C®, Peripheral Component Interconnect Express (PCIe), Compute Express Link (CXL). See, for example, Peripheral Component Interconnect Express (PCIe) Base Specification 1.0 (2002), as well as earlier versions, later versions, and variations thereof. See, for example, Compute Express Link (CXL) Specification revision 2.0, version 0.7 (2019), as well as earlier versions, later versions, and variations thereof.

In a processor, different types of inter-processor communication techniques can be used, such as but not limited to messaging, inter-processor interrupts (IPI), inter-processor communications, and so forth. Cores can be connected in any type of manner, such as but not limited to, bus, ring, or mesh. Cores may be coupled via an interconnect to a system agent (uncore).

A processor can include circuitry that supports the cores (e.g., system agent or uncore). The circuitry that supports the cores can include a shared cache which may include any type of cache (e.g., level 1, level 2, or last level cache (LLC)). The circuitry that supports the cores can include or more of: a memory controller, a shared cache, a cache coherency manager, arithmetic logic units, floating point units, core or processor interconnects, or bus or link controllers. The circuitry that supports the cores can provide one or more of: direct memory access (DMA) engine connection, non-cached coherent master connection, data cache coherency between cores and arbitrate cache requests, or Advanced Microcontroller Bus Architecture (AMBA) capabilities. The circuitry that supports the cores can manage priorities and clock speeds for receive and transmit fabrics and memory controllers.

In some examples, in a multi-socket system, processor sockets 102-0 and 102-1 may operate in different boot modes. Boot mode settings 122 can specify: partition identifier (PID), whether a processor socket is a legacy socket and is to load boot firmware from a memory device, firmware agent, socket identifier (ID), or others. If a processor socket is a legacy socket, interrupts and fixed input output (IO) can be serviced from the legacy socket. A firmware agent can indicate where the system boot firmware is fetched from. A socket ID can indicate an ID of a socket and can be used to determine an address on interfaces (e.g., Platform Environment Control Interface (PECI), Universal Asynchronous Receiver/Transmitter (UART), UPI, or others).

If a processor socket is configured as a legacy socket, the legacy processor socket can load boot firmware by accessing boot firmware from a flash memory (e.g., boot firmware storage 110-0 or 110-1). If a processor socket is configured as a non-legacy socket, the non-legacy processor socket can load boot firmware by communicating with a legacy socket to access the boot firmware. In some examples, boot firmware image or firmware can include one or more of: microcode (ucode), Basic Input/Output System (BIOS), Universal Extensible Firmware Interface (UEFI), a boot loader, an operating system (OS), Authenticated Code Modules (ACM) such as Boot Guard ACM, or others.

Management controller 140 can perform management and monitoring capabilities for system administrators to monitor operation at least of system 100 and devices connected thereto, such as, a network interface device and storage device, using channels, including in-band channels and out-of-band channels. Out-of-band channels can include packet flows or transmission media that communicate metadata and telemetry. In some examples, management controller 140 can be implemented as one or more of: Board Management Controller (BMC), Intel® Management or Manageability Engine (ME), or other devices.

Before or during processor boot and before a processor exits from Global Reset (GR), data center resource orchestration (not shown) can configure boot mode 122 and/or partition mode setting 124 over a management controller out of band (OOB) network. Boot mode 122 and/or partition mode setting 124 can be stored in a non-volatile memory such as flash memory of management controller 140 and/or flash memory of power rail controller 120 (e.g., Complex Programmable Logic Device (CPLD)), to persist beyond Global Reset (GR) or other power cycles. GR can cause power rail controller 120 to adjust power to power rails that supply power to become de-energized except for the always-on domain. GR can cause a loss of stored system state, including error logs.

In some examples, configuration of hardware straps 126 can cause a processor socket (e.g., 102-0 or 102-1) to operate in a specified boot mode set in system boot mode 122 and partition mode in partition mode setting 124. Hardware straps 126 can include a setting (one or more bits) that could be implemented as a latch, switch, jumper, etc.

Table 1 shows an example of hardware strap control for partitioning modes.

TABLE 1

| | CPU0 | | CPU1 | |
|---|---|---|---|---|
| | Non-Partition | Partition | Non-Partition | Partition |
| Strap | Mode | Mode | Mode | Mode |
| PID[1:0] | 2′b00 | 2′b00 | 2′b00 | 2′b01 |
| Firmware agent | 1′b1 | 1′b1 | 1′b0 | 1′b1 |
| LEGACY_SKT | 1′b1 | 1′b1 | 1′b0 | 1′b1 |
| SOCKET_ID[2:0] | 3′b000 | 3′b000 | 3′b001 | 3′b000 |

Socket level partitioning allows a platform with multiple processor sockets to boot in a single system that executes a single operating system (OS) or multiple independent single socket systems that execute multiple operating systems. For example, in a non-partitioned mode, a 2S platform can operate as a single node, and resources connected to the two processor sockets are part of the single node. For instance, processor sockets (e.g., 102-0 and 102-1) in the non-partitioned mode can execute a single boot firmware (e.g., boot firmware stored in 110-0 or 110-1) and perform a handoff platform control to a single OS. Processors (e.g., 104-0 and 104-1) in the non-partitioned mode, including software (e.g., OS or processes) can share resources such as connected memory, cores in different sockets, cache, connected input/output (I/O), device interface-connected devices (e.g., Peripheral Component Interconnect express (PCIe), Compute Express Link (CXL)) and other circuitry, firmware, or software. Processors in the non-partitioned mode can access memory in a coherent manner so that memory is shared among the processors.

For example, in a partitioned mode, a 2S platform can operate as two separate sockets and can operate in independent power states (e.g., S0, S5, and so on), perform separate error handling, and not share one or more of: connected memory, cores in different sockets, cache, isolated input/output (I/O) communication interfaces, or device interface-connected devices. Moreover, in partitioned mode, different sockets (e.g., 102-0 and 102-1) can independently power cycle, utilize different and independent clock signals, different partitions can utilize isolated in-band and out-of-band channels, different partitions can independently communicate with one or more management controllers, different partitions can utilize one or more debug ports, different partitions can independently utilize one or more root of trust devices that authenticate or validate different boot firmware, or others. Multiple processors (e.g., 104-0 and 104-1) can execute separate boot firmware code and handoff platform control to OSs executed by different processors. In a partitioned mode, peripheral or telemetry data may not be shared among different partitioned processor sockets, storage dependency may not be shared among different partitioned processor sockets, and so forth. In a partitioned mode, cross socket isolation can occur whereby sockets have independent power states.

For non-partitioned mode or for a single partition, a home agent (HA) can attempt to achieve data coherency so that a processor receives a most up-to-date copy of content of a cache line that is to be modified by another processor.

Sockets 102-0 and 102-1 can be connected to cross socket coherent interface, sideband links, wake signals for CPU power saving state coordinating, error signals, or others.

I/O interface 150 can include multiple links, where a link can include one or more conductive lines (e.g., electrical or optical). As described herein, communications through links of I/O interface 150 can be isolated for sockets in different partitions in partitioned mode or shared among sockets in non-partitioned mode. Hardware straps or software straps 126 can identify whether links connect sockets in different partitions or a same partition. Initially, interface 150 can operate in non-partitioned mode, but after topology discovery or acknowledgement a link connects different partition, the link of interface 150 connected to different partitions can be disabled. In some examples, partition boot can be staggered so that a single partition performs link training at a given time to avoid activating links between different partitions.

During link training with a target processor socket over a socket interconnect, circuitry and/or platform firmware of an initiator processor socket can read or receive a partition identifier (PID) value of the a processor socket. If the target processor socket is in a same partition as that of the initiator processor socket, the initiator processor socket can perform multi-socket boot flow with this target processor socket. If the initiator processor socket is not in the same partition as the target processor socket, the initiator processor socket can disable the associated socket interconnect (e.g., physical layer interface) and cease further communication with the target processor socket to isolate from the target processor socket.

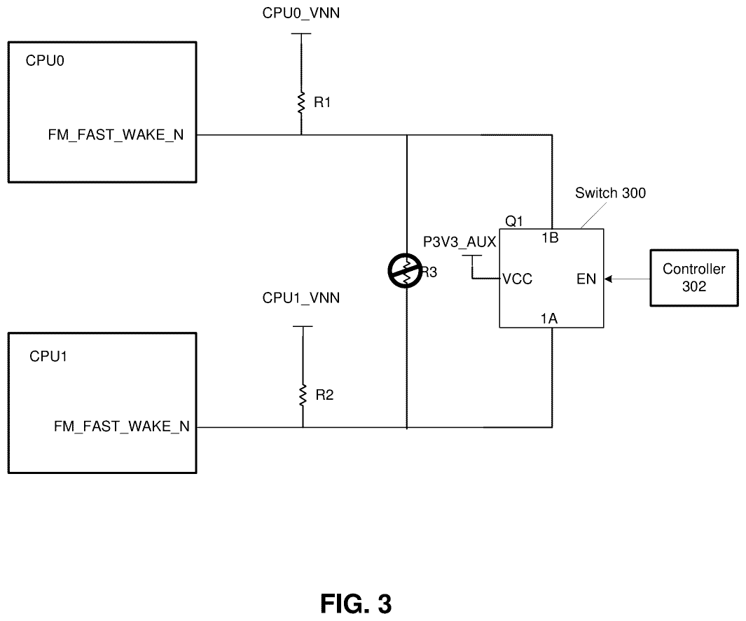

I/O interface 150 can include first type of I/O such as sideband links that provide Fast Wake Signals for CPU power saving state coordinating and error signals. The first type of I/O can be isolated for sockets in different partitions or shared among sockets in non-partitioned mode. For the first type of I/O, an analog multiplexer or switch can be used to connect or disconnect processor sockets based on the partition mode. FIG. 3 depicts another example switch. In a partitioned mode, controller 302 (e.g., a programmable logic device (PLD) such as power rail controller 120) can cause switch 300 to disconnect I/O so that processor sockets CPU0 and CPU1 in different partitions do not communicate. In a non-partition mode, controller 302 can cause switch 300 to connect I/O so that processor sockets CPU0 and CPU1 in a same partition can communicate.

Referring again to FIG. 1, sockets 102-0 and 102-1 can utilize an integrated clock generator 160 that can access a clock generating crystal oscillator. To support partitioned mode, a processor socket can utilize independent clocks 160 without relying on inputs from other sockets, as another socket can be powered-off.

A bootable CPU architecture supports both Joint Test Action Group (JTAG) based debug and I3C interface-based debug. For a JTAG based debug solution, a single JTAG header is available. The JTAG header can be mapped to one socket (one system) at a given time. Processor sockets of a partitioned system can share a single JTAG header as the partitioned systems may not be debugged at the same time.

As defined in MIPI Spec, the I3C Based Debug solution allows multiple sockets to be connected to the same I3C Debug Bus with or without an I3C Hub. Management controller 140 can assign the target I3C address to processor sockets in a partitioned system, dynamically.

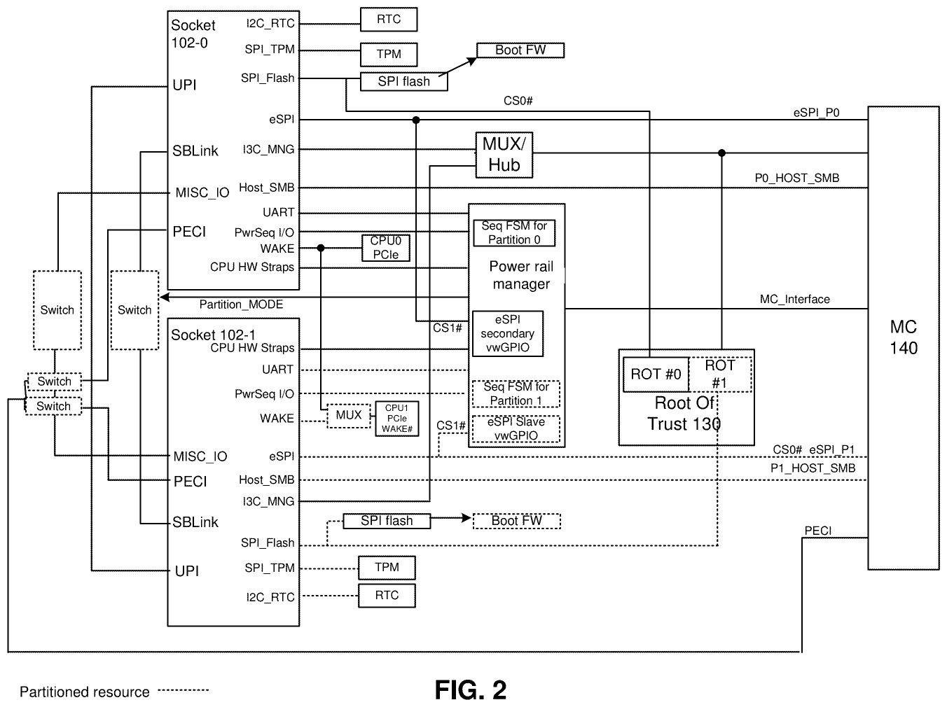

Management controller 140 can utilize in-band and out-of-band management channels (shown in FIG. 2). An in-band management interface enables management controller 140 to communicate with processor sockets. In-band management interface can utilize protocols such as: enhanced Serial Peripheral Interface (eSPI), SMBus, or others. In a non-partitioned system, a single legacy socket can be active and one in-band interface is utilized to connect to management controller 140.

In a partitioned system, at least one socket boots in a legacy socket mode and accordingly at least one socket in the different partition systems utilize in-band management interface. However, management controller 140 may support a single in-band management interface. Various examples, described herein, provide a manner to expand a number of in-band channels for processor sockets of partitioned systems. In some examples, a socket can boot firmware without accessing boot firmware via the legacy socket and the socket can boot firmware without accessing boot firmware from another socket.

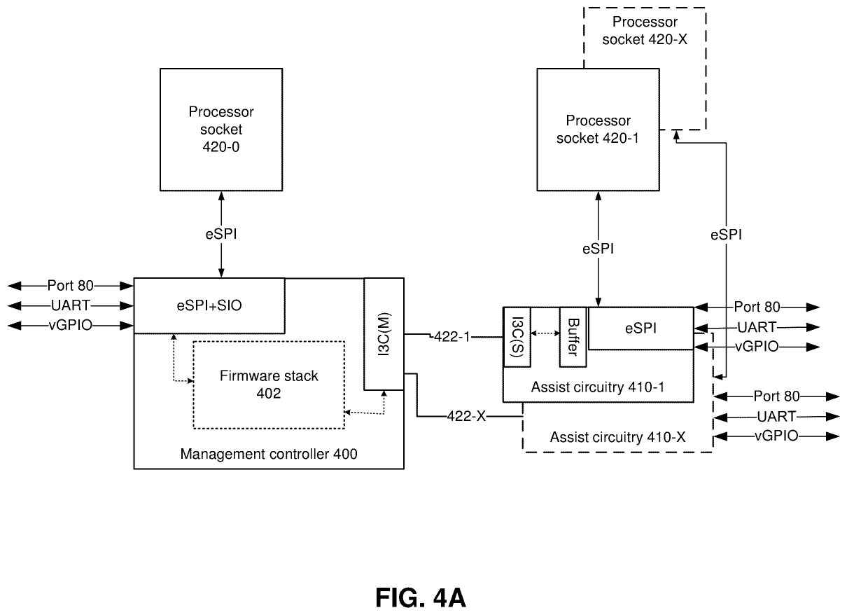

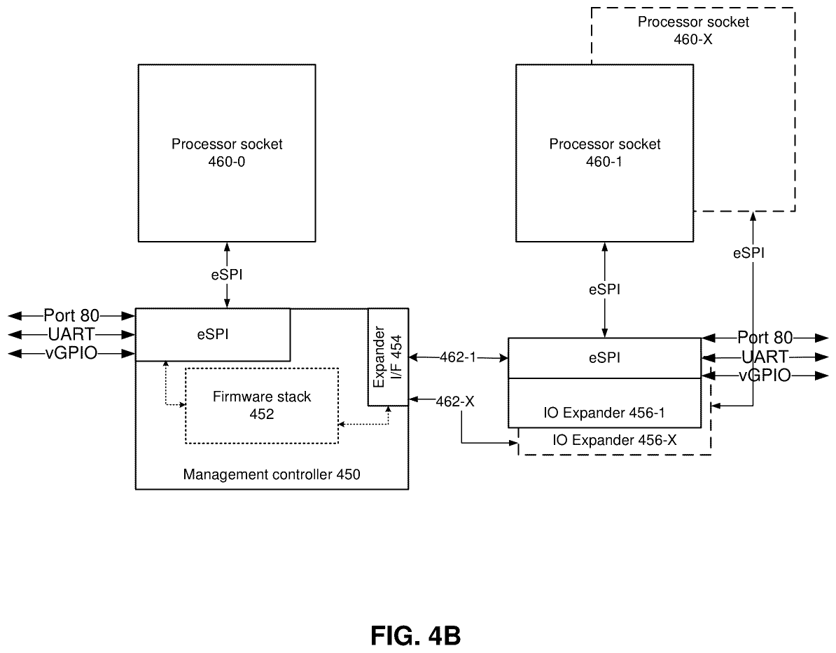

For example, as described with respect to FIG. 4A, under a management controller assist model, a single management controller 400 coupled to processor socket 420-0 can communicate with a management controller assist components 410-1 to 410-X for respective processor sockets 420-1 to 420-X, where X is a non-zero integer, and processor sockets 420-1 to 420-X are in different partitions. Management controller assist component 410-1 to 410-X can increase a number of in-band interfaces available to communicate with management controller 400 so that processor sockets 420-1 to 420-X can communicate with management controller 400. Management controller assist components 410-1 to 410-X can communicate with management controller 400 using interfaces 422-1 to 422-X. Interfaces 422-1 to 422-X can utilize I2C, I3C, eSPI, Universal Asynchronous Receiver/Transmitter (UART), or other protocols. Firmware stack 402, executed by management controller 400, can process messages from assist components 410-1 to 410-X and transmit messages to assist components 410-1 to 410-X.

For example, as described with respect to FIG. 4B, under a management controller expander model, management controller 450 can communicate with I/O expander circuitries 456-1 to 456-X communicatively coupled to respective processor sockets 460-1 to 460-X. Processor sockets 460-1 to 460-X can be in different partitions. I/O expander circuitries 456-1 to 456-X can expose registers to management controller 450 for processing of received data or sent data. Expander interface 454 (e.g., SPI, I3C, or other interface) can connect management controller 450 and I/O expander circuitries 456-1 to 456-X using respective interfaces 462-1 to 462-X. I/O expander circuitries 456-1 to 456-X can increase a number of in-band interfaces available to partitioned systems. Firmware stack 452, executed by management controller 450, can process messages from I/O expander circuitries 456-1 to 456-X and transmit messages to I/O expander circuitries 456-1 to 456-X.

Referring again to FIG. 1, trust system 130 can perform firmware attestation for boot firmware for both socket 102-0 and socket 102-1, where sockets 102-0 and 102-1 boot using boot firmware stored in respective storages 110-0 and 110-1.

Trust system 130 can be implemented as a confidential computing environment or secure enclave that can store boot firmware. The confidential computing environment or secure enclave can be created using one or more of: total memory encryption (TME), multi-key total memory encryption (MKTME), Trusted Domain Extensions (TDX), Double Data Rate (DDR) encryption, function as a service (FaaS) container encryption or an enclave/TD (trust domain), Intel® SGX, Intel® TDX, AMD Memory Encryption Technology, AMD Secure Memory Encryption (SME) and Secure Encrypted Virtualization (SEV), AMD Secure Encrypted Virtualization-Secure Nested Paging (AMD SEV-SNP), ARM® TrustZone®, ARM® Realms and Confidential Compute, Apple Secure Enclave Processor, Qualcomm® Trusted Execution Environment, Distributed Management Task Force (DMTF) Security Protocol and Data Model (SPDM) specification, virtualization-based isolation such as Intel VTd and AMD-v, or others.

A processor can be implemented as one or more of: system on chip (SoC) or a physical package that includes one or more discrete dies or tiles connected by mesh or other connectivity as well as an interface (not shown) and heat dispersion (not shown). A die can include semiconductor devices that include one or more processing devices or other circuitry. A tile can include semiconductor devices that include one or more processing devices or other circuitry. For example, a physical package can include one or more dies, plastic or ceramic housing for the dies, and conductive contacts conductively coupled to a circuit board.

For system 100, thermal, power, and manageability can be maintained at the chassis level, irrespective of whether the partitioned system is functioning in partitioned mode or non-partitioned mode.

FIG. 2 depicts an example system. As described with respect to FIG. 1, processor sockets 102-0 and 102-1 can operate in partitioned on non-partitioned modes. To partition processor sockets, via a graphical user interface (GUI) or command line interface, a system administrator can select sockets to operate in non-partitioned or partitioned mode.

The following Table 2 provides an example description of pins labeled in FIG. 2.

TABLE 2

| Pin | Example description |
|---|---|
| I2C_RTC | The I2C interface connected to a discrete |
| | common I2C RTC device |
| SPI_TPM | The SPI interface dedicated for trusted platform |
| | module (TPM) Device. A TPM can utilize |
| | cryptography to securely store data for |
| | platform authentication. |
| SPI_Flash | Access to boot firmware |
| eSPI | The enhanced SPI interface between CPU and |
| | Platform components (e.g., management |
| | controller and power rail manager) |
| I3C_MNG | Out-of-Band Management and Attestation |
| | Interface connected to management controller |
| | and Platform Root of Trust |
| Host_SMB | Host SMBus interface connected to platform |
| | SMBus Device and management controller |
| UART | The serial UART interface. |
| PwrSeq I/O | The Power Sequence related I/O signal that |
| | control and Reset/PWRGD to a processor |
| WAKE | Wake signal input from platform to CPU |
| | to wake-up system. |
| CPU HW Straps | The Hardware Straps to configure |
| | CPU boot modes. |
| eSPI_P0 | eSPI interface to Partition 0 |
| P0_HOST_SMB | SMBus interface to Partition 0 |
| eSPI_P1 | eSPI interface to Partition 1 |
| P1_HOST_SMB | SMBus interface to Partition 1 |

In a bootable CPU architecture, there are limited number of interfaces that operate differently or in different enable/disable states depending on whether the CPU is booted in legacy socket or non-legacy socket. Table 3 shows a platform configuration to support both partitioned mode and non-partitioned modes.

TABLE 3
Bootable CPU Interface Control

| | CPU0 | | | CPU1 | | |
|---|---|---|---|---|---|---|
| Interface/ | Platform | Non- | Partition | Platform | Non- | Partition |
| Signal Name | Connectivity | Partition | Mode | Connectivity | Partition | Mode |
| | | Mode | | | Mode | |
| QSPI Flash | Device | Active | Active | DAF | Inactive | Active |
| | Attached | | | Mode: | | |
| | Flash | | | 1.8 V | | |
| | (DAF) | | | SPI Flash | | |
| | Mode: | | | | | |
| | 1.8 V SPI | | | | | |
| | Flash | | | | | |
| eSPI Device | Inactive | Inactive | eDAF | Inactive | Inactive | |
| Attached Flash | | | Mode: | | | |
| (eDAF) Mode: | | | Terminated | | | |
| Terminated | | | | | | |
| SPI TPM | 1.8 V SPI | Active | Active | 1.8 V SPI | Inactive | Active |
| | TPM | | | TPM | | |
| | Device/ | | | Device/ | | |
| | Module | | | Module | | |
| | Connector | | | Connector | | |
| eSPI | BMC | Active | Active | eSPI | Inactive | Active |
| | (CS0#) | | | device for | | |
| | or CPLD | | | Partitioned | | |
| | (CS1#, | | | Mode | | |
| | Optional | | | (BMC/ | | |
| | for | | | Satellite | | |
| | Virtual | | | BMC | | |
| | Wire) | | | or | | |
| | | | | CPLD) | | |
| ADR | Platform | Active | Active | Platform | Inactive | Active |
| | PLD/ | | | PLD/ | | |
| | Discrete | | | Discrete | | |
| | Circuit | | | Circuit | | |
| GPIO | Platform | Active | Active | Platform | Inactive | Active |
| | PLD/ | | | PLD/ | (note 1) | |
| | Discrete | | | Discrete | | |
| | Circuit | | | Circuit | | |
| Host SMBus | Platform | Active | Active | Platform | Inactive | Active |
| | Device/ | | | Device/ | | |
| | BMC | | | BMC/ | | |
| | | | | (Satellite | | |
| | | | | BMC) | | |
| UART | Debug | Active | Active | Debug | Inactive | Active |
| | Port/ | | | Port/ | | |
| | BMC | | | BMC | | |
| I2C RTC | Common | Active | Active | Common | Inactive | Active |
| | I2C | | | I2C | | |
| | RTC | | | RTC | | |
| | Device | | | Device | | |
| PLTRST_ | Platform | Active | Active | Platform | Inactive | Active |
| SYNC#/SLP_ | PLD | | | PLD | | |
| Sx/SYS_RE | | | | | | |
| SET/ | | | | | | |
| PWRBUTTON#/ | | | | | | |
| WAKE# | | | | | | |
| and so forth | | | | | | |

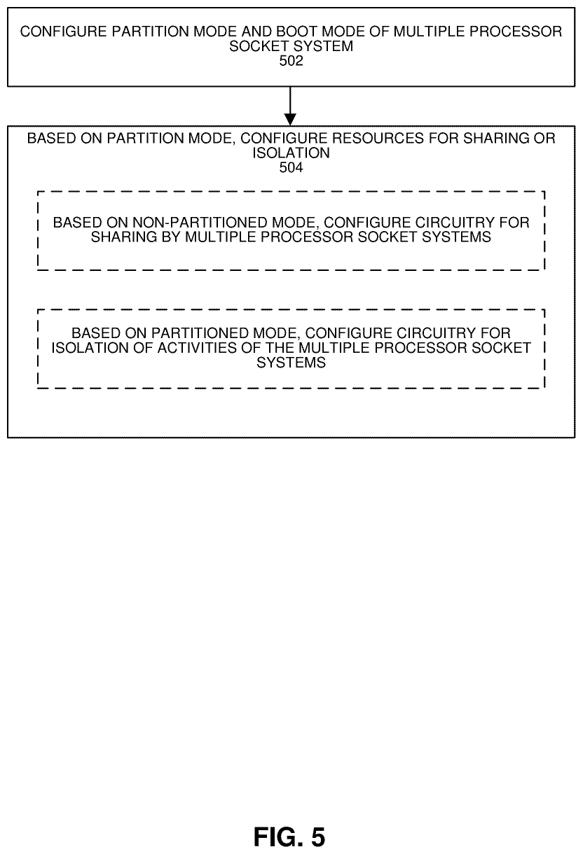

FIG. 5 depicts an example process. The process can be performed by a system with multiple processor sockets. In some examples, the processors sockets are coupled to at least one processor that includes boot circuitry (e.g., a bootable processor). At 502, the system with multiple processors can be configured to operate in a non-partition or partition mode and according to a boot mode. For example, under a non-partition mode, processor sockets can share resources and operate as a single processor socket. For example, under a partition mode, processor sockets in a same partition can share resources and operate as a single processor socket but processor sockets in different partitions can operate as separate and independent processor sockets. The configuration can be specified in a register or hardware or software straps.

At 504, based on the partition mode (e.g., non-partitioned or partitioned), circuitry can be shared or isolated. For a non-partitioned mode, circuitry including clock signal, power rail manager, interfaces, root of trust, management controller, management controller in-band and out-of-band interfaces, boot firmware storage, and other circuitry can be shared by processors of the processor sockets of the system. For a partitioned mode, processor sockets of different partitions utilize isolated circuitry. Isolation of circuitry can include one or more of: isolation of inter-socket interfaces, isolation of interfaces used by sockets in different partitions, providing separate clock signals to different partitions, providing access to debug topology by a single partition at a time, partitioned use of platform root of trust, use of extender or assist circuitry to communicate with a management controller, loading of boot firmware from different flash devices, or others.

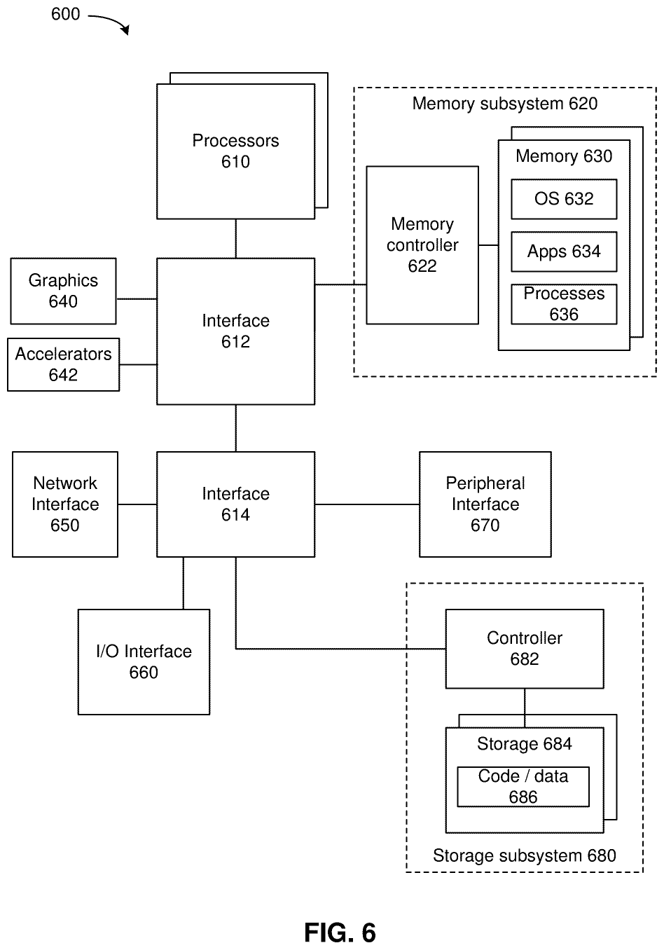

FIG. 6 depicts a system. In some examples, circuitry of system 600 (e.g., processor 610, graphics 640, accelerators 642, interface 612, and/or interface 614) can be partitioned or non-partitioned, as described herein. System 600 includes processor 610, which provides processing, operation management, and execution of instructions for system 600. Processor 610 can include any type of microprocessor, central processing unit (CPU), graphics processing unit (GPU), XPU, processing core, or other processing hardware to provide processing for system 600, or a combination of processors. An XPU can include one or more of: a CPU, a graphics processing unit (GPU), general purpose GPU (GPGPU), and/or other processing units (e.g., accelerators or programmable or fixed function FPGAs). Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 600 includes interface 612 coupled to processor 610, which can represent a higher speed interface or a high throughput interface for system components that needs higher bandwidth connections, such as memory subsystem 620 or graphics interface components 640, or accelerators 642. Interface 612 represents an interface circuit, which can be a standalone component or integrated onto a processor die. Where present, graphics interface 640 interfaces to graphics components for providing a visual display to a user of system 600. In one example, graphics interface 640 generates a display based on data stored in memory 630 or based on operations executed by processor 610 or both. In one example, graphics interface 640 generates a display based on data stored in memory 630 or based on operations executed by processor 610 or both.

Accelerators 642 can be a programmable or fixed function offload engine that can be accessed or used by a processor 610. For example, an accelerator among accelerators 642 can provide data compression (DC) capability, cryptography services such as public key encryption (PKE), cipher, hash/authentication capabilities, decryption, or other capabilities or services. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 642 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

Applications 634 and/or processes 636 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 632 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a device that is in the same data center or rack or a remote device, which can include sending data stored in memory. Network interface 650 can receive data from a remote device, which can include storing received data into memory. In some examples, packet processing device or network interface device 650 can refer to one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU). An edge processing unit (EPU) can include a network interface device that utilizes processors and accelerators (e.g., digital signal processors (DSPs), signal processors, or wireless specific accelerators for Virtualized radio access networks (vRANs), cryptographic operations, compression/decompression, and so forth).

In one example, system 600 includes one or more input/output (I/O) interface(s) 660. I/O interface 660 can include one or more interface components through which a user interacts with system 600. Peripheral interface 670 can include any hardware interface not specifically mentioned above. Peripherals refer generally to devices that connect dependently to system 600.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 686 in a persistent state (e.g., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (e.g., the value or state of the data is indeterminate if power is interrupted to system 600). In one example, storage subsystem 680 includes controller 682 to interface with storage 684. In one example controller 682 is a physical part of interface 614 or processor 610 or can include circuits or logic in both processor 610 and interface 614.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 600 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 600 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes one or more examples and includes an apparatus that includes: multiple processor sockets comprising processors connected thereto, wherein at least one of the processors comprises circuitry to load boot firmware; and first circuitry to: based on a first mode of operation: configure the multiple processor sockets to operate with a single memory address space and share interfaces and based on a second mode of operation: configure the interfaces accessible to the multiple processor sockets to provide isolated communications to processor sockets in different partitions and configure the multiple processor sockets to operate in independent memory address spaces.

Example 2 includes one or more examples, wherein the first mode of operation comprises: the multiple processor sockets are in a same partition, a first processor socket of the multiple processor sockets is to fetch boot firmware for a second processor socket of the multiple processor sockets, and the multiple processor sockets are to operate as a single memory coherent processor socket.

Example 3 includes one or more examples, wherein the second mode of operation comprises the multiple processor sockets are in different partitions and wherein: for the independent memory address spaces, a translation of a first address for a first processor socket of the multiple processor sockets corresponds to a first physical address and a translation of a second address for a second processor socket of the multiple processor sockets corresponds to a second physical address and the first and second physical addresses are different.

Example 4 includes one or more examples and includes a power management circuitry to set operation in the first mode of operation or the second mode of operation.

Example 5 includes one or more examples and includes a power management circuitry to: based on the first mode of operation: provide voltage to the multiple processor sockets so that the multiple processor sockets operate in a same power state and based on the second mode of operation: control a power sequence for boot for power state transitions so that different partitions operate in independent power states.

Example 6 includes one or more examples, wherein: based on the first mode of operation: authenticate boot firmware prior to execution of the boot firmware and based on the second mode of operation: authenticate a first boot firmware prior to execution of the first boot firmware by a first processor socket of the multiple processor sockets and authenticate a second boot firmware prior to execution of the second boot firmware by a second processor socket of the multiple processor sockets.

Example 7 includes one or more examples, wherein: based on the first mode of operation: the second circuitry is to provide a single clock signal to processor sockets in a same partition and based on the second mode of operation: the second circuitry is to provide separate clock signals to processor sockets in different partitions.

Example 8 includes one or more examples and includes a method that includes: for a system comprising multiple processor sockets, wherein at least one of the processor sockets of the multiple processor sockets comprises a processor and circuitry to load boot firmware: based on a first mode of operation: configure the multiple processor sockets to operate with a single memory address space and share interfaces and based on a second mode of operation: configure the interfaces accessible to the multiple processor sockets to provide isolated communications to processor sockets in different partitions and configure the multiple processor sockets to operate in independent memory address spaces.

Example 9 includes one or more examples, wherein the first mode of operation comprises: the multiple processor sockets are in a same partition and a first processor socket of the multiple processor sockets comprises a bootable processor that is to fetch the boot firmware for a second bootable processor socket of the multiple processor sockets.

Example 10 includes one or more examples, wherein the second mode of operation comprises: the multiple processor sockets are in different partitions and a first bootable processor socket of the multiple processor sockets comprises a bootable processor that is to fetch boot firmware for the first bootable processor socket.

Example 11 includes one or more examples and includes setting operation in the first mode of operation or the second mode of operation by configuring hardware straps.

Example 12 includes one or more examples and includes based on the first mode of operation: providing voltage to the multiple processor sockets so that the multiple processor sockets operate in a same power state and based on the second mode of operation: controlling a power sequence for boot for power state transitions so that different partitions operate in independent power states.

Example 13 includes one or more examples and includes based on the first mode of operation: authenticating boot firmware prior to execution of the boot firmware by a processor socket of the multiple processor sockets and based on the second mode of operation: authenticating a first boot firmware prior to execution of the first boot firmware by a first bootable processor socket of the multiple processor sockets and authenticating a second boot firmware prior to execution of the second boot firmware by a second bootable processor socket of the multiple processor sockets.

Example 14 includes one or more examples and includes based on the first mode of operation: providing a single clock signal to processor sockets in a same partition and based on the second mode of operation: providing separate clock signals to processor sockets in different partitions.

Example 15 includes one or more examples and includes based on the second mode of operation: debugging processors sockets of the multiple processor sockets serially so that a single processor socket is debugged at a time.

Example 16 includes one or more examples and includes at least one non-transitory computer-readable medium comprising instructions stored thereon, that if executed by one or more processors, cause the one or more processors to: configure a system comprising multiple processor sockets, wherein at least one of the processor sockets of the multiple processor sockets comprises a processor and circuitry to load boot firmware to: based on a first mode of operation: configure the multiple processor sockets to operate with a single memory address space and share interfaces and based on a second mode of operation: configure the interfaces accessible to the multiple processor sockets to provide isolated communications to processor sockets in different partitions and configure the multiple processor sockets to operate in independent memory address spaces.

Example 17 includes one or more examples, wherein: the multiple processor sockets are in a same partition and a first bootable processor socket of the multiple processor sockets comprises a bootable processor that is to fetch the boot firmware for a second bootable processor socket of the multiple processor sockets.

Example 18 includes one or more examples and includes instructions stored thereon, that if executed by one or more processors, cause the one or more processors to: configure the system to: based on the first mode of operation: providing voltage to the multiple processor sockets so that the multiple processor sockets operate in a same power state and based on the second mode of operation: controlling a power sequence for boot for power state transitions so that different partitions operate in independent power states.

Example 19 includes one or more examples and includes instructions stored thereon, that if executed by one or more processors, cause the one or more processors to: configure the system to: based on the first mode of operation: authenticating boot firmware prior to execution of the boot firmware by a processor socket of the multiple processor sockets and based on the second mode of operation: authenticating a first boot firmware prior to execution of the first boot firmware by a first bootable processor socket of the multiple processor sockets and authenticating a second boot firmware prior to execution of the second boot firmware by a second bootable processor socket of the multiple processor sockets.

Example 20 includes one or more examples and includes instructions stored thereon, that if executed by one or more processors, cause the one or more processors to: configure the system to: based on the first mode of operation: providing a single clock signal to processor sockets in a same partition and based on the second mode of operation: providing separate clock signals to processor sockets in different partitions.

1. An apparatus comprising:
multiple processor sockets comprising processors connected thereto, wherein at least one of the processors comprises circuitry to load boot firmware; and
first circuitry to:
based on a first mode of operation: configure the multiple processor sockets to operate with a single memory address space and share interfaces and
based on a second mode of operation: configure the interfaces accessible to the multiple processor sockets to provide isolated communications to processor sockets in different partitions and configure the multiple processor sockets to operate in independent memory address spaces.

2. The apparatus of claim 1, wherein the first mode of operation comprises:
the multiple processor sockets are in a same partition,
a first processor socket of the multiple processor sockets is to fetch boot firmware for a second processor socket of the multiple processor sockets, and
the multiple processor sockets are to operate as a single memory coherent processor socket.

3. The apparatus of claim 1, wherein the second mode of operation comprises the multiple processor sockets are in different partitions and wherein:
for the independent memory address spaces, a translation of a first address for a first processor socket of the multiple processor sockets corresponds to a first physical address and a translation of a second address for a second processor socket of the multiple processor sockets corresponds to a second physical address and the first and second physical addresses are different.

4. The apparatus of claim 1, comprising a power management circuitry to set operation in the first mode of operation or the second mode of operation.

5. The apparatus of claim 1, comprising a power management circuitry to:
based on the first mode of operation: provide voltage to the multiple processor sockets so that the multiple processor sockets operate in a same power state and
based on the second mode of operation: control a power sequence for boot for power state transitions so that different partitions operate in independent power states.

6. The apparatus of claim 1, comprising a second circuitry, wherein:
based on the first mode of operation: authenticate boot firmware prior to execution of the boot firmware and
based on the second mode of operation: authenticate a first boot firmware prior to execution of the first boot firmware by a first processor socket of the multiple processor sockets and authenticate a second boot firmware prior to execution of the second boot firmware by a second processor socket of the multiple processor sockets.

7. The apparatus of claim 1, comprising a second circuitry, wherein:
based on the first mode of operation: the second circuitry is to provide a single clock signal to processor sockets in a same partition and
based on the second mode of operation: the second circuitry is to provide separate clock signals to processor sockets in different partitions.

8. A method comprising:
for a system comprising multiple processor sockets, wherein at least one of the processor sockets of the multiple processor sockets comprises a processor and circuitry to load boot firmware:
based on a first mode of operation: configure the multiple processor sockets to operate with a single memory address space and share interfaces and
based on a second mode of operation: configure the interfaces accessible to the multiple processor sockets to provide isolated communications to processor sockets in different partitions and configure the multiple processor sockets to operate in independent memory address spaces.

9. The method of claim 8, wherein the first mode of operation comprises:
the multiple processor sockets are in a same partition and
a first processor socket of the multiple processor sockets comprises a bootable processor that is to fetch the boot firmware for a second bootable processor socket of the multiple processor sockets.

10. The method of claim 8, wherein the second mode of operation comprises:
the multiple processor sockets are in different partitions and
a first bootable processor socket of the multiple processor sockets comprises a bootable processor that is to fetch boot firmware for the first bootable processor socket.

11. The method of claim 8, comprising:
setting operation in the first mode of operation or the second mode of operation by configuring hardware straps.

12. The method of claim 8, comprising:
based on the first mode of operation: providing voltage to the multiple processor sockets so that the multiple processor sockets operate in a same power state and
based on the second mode of operation: controlling a power sequence for boot for power state transitions so that different partitions operate in independent power states.

13. The method of claim 8, comprising:
based on the first mode of operation: authenticating boot firmware prior to execution of the boot firmware by a processor socket of the multiple processor sockets and
based on the second mode of operation: authenticating a first boot firmware prior to execution of the first boot firmware by a first bootable processor socket of the multiple processor sockets and authenticating a second boot firmware prior to execution of the second boot firmware by a second bootable processor socket of the multiple processor sockets.

14. The method of claim 8, comprising:
based on the first mode of operation: providing a single clock signal to processor sockets in a same partition and
based on the second mode of operation: providing separate clock signals to processor sockets in different partitions.

15. The method of claim 8, comprising:
based on the second mode of operation: debugging processors sockets of the multiple processor sockets serially so that a single processor socket is debugged at a time.

16. At least one non-transitory computer-readable medium comprising instructions stored thereon, that if executed by one or more processors, cause the one or more processors to:
configure a system comprising multiple processor sockets, wherein at least one of the processor sockets of the multiple processor sockets comprises a processor and circuitry to load boot firmware to:
based on a first mode of operation: configure the multiple processor sockets to operate with a single memory address space and share interfaces and
based on a second mode of operation: configure the interfaces accessible to the multiple processor sockets to provide isolated communications to processor sockets in different partitions and configure the multiple processor sockets to operate in independent memory address spaces.

17. The at least one non-transitory computer-readable medium of claim 16, wherein:
the multiple processor sockets are in a same partition and
a first bootable processor socket of the multiple processor sockets comprises a bootable processor that is to fetch the boot firmware for a second bootable processor socket of the multiple processor sockets.

18. The at least one non-transitory computer-readable medium of claim 16, comprising instructions stored thereon, that if executed by one or more processors, cause the one or more processors to:
configure the system to:
based on the first mode of operation: providing voltage to the multiple processor sockets so that the multiple processor sockets operate in a same power state and
based on the second mode of operation: controlling a power sequence for boot for power state transitions so that different partitions operate in independent power states.

19. The at least one non-transitory computer-readable medium of claim 16, comprising instructions stored thereon, that if executed by one or more processors, cause the one or more processors to:
configure the system to:
based on the first mode of operation: authenticating boot firmware prior to execution of the boot firmware by a processor socket of the multiple processor sockets and
based on the second mode of operation: authenticating a first boot firmware prior to execution of the first boot firmware by a first bootable processor socket of the multiple processor sockets and authenticating a second boot firmware prior to execution of the second boot firmware by a second bootable processor socket of the multiple processor sockets.

20. The at least one non-transitory computer-readable medium of claim 16, comprising instructions stored thereon, that if executed by one or more processors, cause the one or more processors to:
configure the system to:
based on the first mode of operation: providing a single clock signal to processor sockets in a same partition and
based on the second mode of operation: providing separate clock signals to processor sockets in different partitions.
